(19) United States
(12) Patent Application Publication
(10) Pub. No.: US 2016/0176186 A1
(43) Pub. Date: Jun. 23, 2016

(54) VARIABLE DATA LITHOGRAPHY SYSTEM WITH EMBEDDED PLASMONIC FILLERS IN A PRINTING PLATE

(71) Applicant: Palo Alto Research Center Incorporated, Palo Alto, CA (US)

(72) Inventors: Sourobh RAYCHAUDHURI, Mountain View, CA (US); Timothy D. STOWE, Alameda, CA (US)

(21) Appl. No.: 14/578,302

(22) Filed: Dec. 19, 2014

(51) Int. Cl. B41J 2/005

(52) U.S. Cl. CPC B41J 2/0057

(57) ABSTRACT

An apparatus and method for providing rewritable printing by utilizing nanoparticles at the printing plate to reduce power requirements for imaging modules in a variable data lithography system is provided. The disclosed embodiments propose a printing plate surface that is made up of an elastomer and incorporates engineered nanoparticles that have high optical absorption properties to improve ablation performance. The exact material, composition and geometry of the engineered nanoparticles are optimized for the specified imaging module without altering plate properties. The apparatus and method use electromagnetic radiation coupled with a nano-filler to locally apply heat to a dampening solution on the printing plate to form a latent image. The nanoparticles do not undergo a physical or chemical change beyond heating up.

### BACKGROUND

The present disclosure is related to marking and printing methods and systems, and more specifically to a method and apparatus for using plasmonic nanoparticles that may be stimulated with electromagnetic radiation to variably mark or print data at reduced power consumption.

Offset lithography is a common method of printing today. For the purpose hereof, the terms “printing” and “marking” are interchangeable. In a typical lithographic process a printing plate, which may be a flat plate, the surface of a cylinder, belt, and the like, is formed to have “image regions” formed of hydrophobic and oleophilic material, and “non-image regions” formed of a hydrophilic material. The image regions are regions corresponding to the areas on the final print (i.e., the target substrate) that are occupied by a printing or a marking material such as ink, whereas the non-image regions are the regions corresponding to the areas on the final print that are not occupied by the marking material.

The Variable Data Lithography (also referred to as Digital Lithography or Digital Offset) printing process begins with a fountain solution used to dampen an imaging plate on an imaging drum. The fountain solution forms a film on the plate that is in the range of 100 nm to 1 μm thick. The drum rotates to an ‘exposure’ station where a high power laser imager is used to remove the fountain solution at the locations where the image pixels are to be formed. This forms a fountain solution based ‘latent image’. The drum then further rotates to a ‘development’ station where lithographic-like ink is brought into contact with the fountain solution based ‘latent image’ and ink ‘develops’ onto the places where the laser has removed the fountain solution. The ink is usually hydrophobic for better placement on the plate and substrate. An ultra violet (UV) light may be applied so that photo-initiators in the ink may partially cure the ink to prepare it for high efficiency transfer to a print media such as paper. The drum then rotates to a transfer station where the ink is transferred to a printing media such as paper. The plate is compliant, so an offset blanket is not used to aid transfer. UV light may be applied to the paper with ink to fully cure the ink on the paper. The ink is on the order of one (1) micron pile height on the paper.

The formation of the image on the printing plate is done with imaging modules each using a linear output high power infrared (IR) laser to illuminate a digital light projector (DLP) multi-mirror array, also referred to as the “DMD” (Digital Micromirror Device). The mirror array is similar to what is commonly used in computer projectors and some televisions. The laser provides constant illumination to the mirror array. The mirror array deflects individual mirrors to form the pixels on the image plane to pixel-wise evaporate the fountain solution on the silicone plate. If a pixel is not to be turned on, the mirrors for that pixel deflect such that the laser illumination for that pixel does not hit the silicone surface, but goes into a chilled light dump heat sink. A single laser and mirror array form an imaging module that provides imaging capability for approximately one (1) inch in the cross-process direction. Thus, a single imaging module simultaneously images a one (1) inch by one (1) pixel line of the image for a given scan line. At the next scan line, the imaging module images the next one (1) inch by one (1) pixel line segment. By using several imaging modules, comprising several lasers and several mirror-arrays, butted together, imaging function for a very wide cross-process width is achieved.

Due to the need to evaporate the fountain solution, in the imaging module, power consumption of the laser accounts for the majority of total power consumption of the whole system. It is, therefore, vital to scheme how much electric power of the laser and the electronics is saved in terms of realizing power saving of the whole system. Such being the case, a variety of power saving technologies for the imaging modules have been proposed. For example, the schemes to reduce the size of the image formed on the printing plate, changing the depth of the pixel, and substituting less powerful image creating source such as a conventional Raster Output Scanner (ROS). For example, to evaporate a one (1) micron thick film of water, at process speed requirements of up to five meters per second (5 m/s), requires on the order of 100,000 times more power than a conventional xerographic ROS imager. In addition, cross-process width requirements are on the order of 36 inches, which makes the use of a scanning beam imager problematic. Thus, a special imager design is required that reduces power consumption in a printing system. An over looked area of power conservation is the printing plate surface in the digital lithographic printing process.

For the reasons stated above, and for other reasons stated below which will become apparent to those skilled in the art upon reading and understanding the present specification, there is a need in the art for lowering power consumption at the imaging module. There is also a need for increasing the optical efficiency of printing plates, while maintaining plate properties, to lower the laser power requirement of a digital offset printing system.

### SUMMARY

An apparatus and method for providing rewritable printing by utilizing nanoparticles at the printing plate to reduce power requirements for imaging modules in a variable data lithography system is provided. The disclosed embodiments propose a printing plate surface that is made up of an elastomer and incorporates engineered nanoparticles that have high optical absorption properties to improve ablation performance. The exact material, composition and geometry of the engineered nanoparticles are optimized for the specified imaging module without altering plate properties. The apparatus and method use electromagnetic radiation coupled with nano-fillers or nanoparticles to locally apply heat to a dampening solution on the printing plate to form a latent image. The nanoparticles do not undergo a physical or chemical change beyond heating up.

### BRIEF DESCRIPTION OF THE DRAWINGS

FIG. 1 is a side view of a system for variable lithography in accordance to an embodiment;

FIG. 2 is a cut-away side view of a printing plate of an imaging member and structural mounting layer with nano-heaters in the form of plasmonic nanoparticles embedded at or below the surface of the layer in accordance to an embodiment;

FIG. 3 is a cut-away side view of a printing plate and plasmonic nanoparticles in accordance to an embodiment;

FIG. 4 is a magnified cut-away side view of the printing plate shown in FIG. 2, having a dampening solution applied thereover and patterned by a beam B in accordance to an embodiment;

FIG. 5 is an illustration of measured optical transmission and diffuse reflectivity of plasmonic nanoparticles in accordance to an embodiment;

FIG. 6 are scanning electron micrographs (SEM) of silver nanoparticles, after being deposited on a glass slide, that were used to create the transmission and reflectivity measurement shown in FIG. 5 in accordance to an embodiment;

FIG. 7 is an illustration of heat flow for a plasmonic nanoparticle as a function of distance for a giving wavelength of electromagnetic radiation in accordance to an embodiment; and

FIG. 8 is a flowchart of a method to produce a latent image on an arbitrarily reimageable surface layer by selectively removing portions of a dampening solution on the surface using electromagnetic radiation and heat from plasmonic nanoparticles in accordance to an embodiment.

### DETAILED DESCRIPTION

The disclosed embodiment pertains to a “green” energy saving scheme for Variable Data Lithography by improving the printing plate surface to absorb electromagnetic radiation in order to capture as much of the energy as possible, but also such that it absorbs the energy close to an interface so that the thermal energy from plasmonic nanoparticles can be efficiently transferred to a dampening solution causing it to heat up and evaporate at certain locations form a discernible pattern such as a latent image.

Aspects of the disclosed embodiments relate to an imaging member for disposition within a variable data lithography system, comprising a structural mounting layer having on one face thereof a matrix layer with plasmonic nanoparticles embedded at or below the surface of the matrix layer, wherein said plasmonic nanoparticles generate heat when exposed to an incident wavelength of electromagnetic radiation; an arbitrarily reimageable surface layer formed by a dampening solution disposed over said one face of the structural mounting layer; wherein the electromagnetic radiation and the heat from the plasmonic nanoparticles selectively remove portions of the dampening solution so as to produce a latent image on the arbitrarily reimageable surface layer.

Further aspects of the disclosed embodiments relate to an imaging member wherein the plasmonic nanoparticles have a controlled shape to efficiently absorb light at the same frequency as the electromagnetic radiation in a variable data lithography system.

Further aspects of the disclosed embodiments relate to an imaging member wherein the controlled shape is a nanotriangle, nanorectangle, or nanodisc.

Further aspects of the disclosed embodiments relate to an imaging member wherein the controlled shape has a physical size that is smaller than the wavelength of the electromagnetic radiation.

Further aspects of the disclosed embodiments relate to an imaging member wherein the plasmonic nanoparticles are encapsulated to provide an insulating barrier and to prevent direct contact between particles.

Further aspects of the disclosed embodiments relate to an imaging member wherein a silica coating encapsulates the plasmonic nanoparticles and wherein the plasmonic nanoparticles are formed from silver, gold, copper, aluminum, or any combination thereof.

Further aspects of the disclosed embodiments relate to an imaging member wherein the plasmonic nanoparticles are embedded on the top imaging layer of the printing plate to a depth of 2 microns or less.

Aspects of the disclosed embodiments relate to a variable data lithography system, comprising an imaging member comprising an arbitrarily reimageable surface having on one face thereof a matrix layer with plasmonic nanoparticles embedded at or below the surface of the matrix layer, wherein said plasmonic nanoparticles generate heat when exposed to an incident wavelength of electromagnetic radiation; a dampening solution subsystem for applying a layer of dampening solution to said arbitrarily reimageable surface layer; a patterning subsystem for selectively removing portions of the dampening solution layer, by electromagnetic radiation and the heat from the plasmonic nanoparticles, so as to produce a latent image in the dampening solution; an inking subsystem for applying ink over the arbitrarily reimageable surface layer such that said ink selectively occupies regions of the reimageable surface layer where dampening solution was removed by the patterning subsystem to thereby produce an inked latent image; and an image transfer subsystem for transferring the inked latent image to a substrate.

Aspects of the disclosed embodiments relate to a method comprising using a structural mounting layer to provide mechanical support and strength for the reimageable surface layer.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

As used herein, the term “nanostructure”, “nano-particle”, “nanoparticle” means and includes any particle having an average particle size of about 1 μm or less. The term “plasmonic nanoparticles” refers to nanostructures that have very strong absorption (and scattering) spectrum that is tunable by changing the shape, the composition or the medium around their surfaces. In plasmonic nanoparticles a great percentage of electromagnetic radiation that is absorbed will cause heating of the nanoparticle. Plasmonic nanoparticles include, but are not limited to, nanotriangles, nanorods, nanorectangles, nanotubes, nanodiscs, and the like.

Embodiments as disclosed herein may also include computer-readable media for carrying or having computer-executable instructions or data structures stored thereon for operating such devices as controllers, sensors, and electromechanical devices. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

The term “substrate” or “print media” generally refers to a usually flexible, sometimes curled, physical sheet of paper, cloth, cardboard, plastic or composite sheet film, ceramic, glass, wood, sheet metal or other suitable physical print media substrate for images.

The term “variable data printing”, “variable data lithography”, “digital offset”, or “digital printing” generally refers to variable data printing with lithographic inks on media/substrate such as paper cut sheets, paper webs, and/or other material suitable for printing with lithographic ink. Variable data printing is superior for print jobs that contain variable data documents, that is, documents that vary in image content from page-to-page.

The term “dampening solution” should be interpreted broadly, and covers all fluids used for such purpose in offset printing such as variable data lithography. Fountain solution, dampening water, water based film, fountain additive, fountain solution additive and dampening agent should all be comprised within the meaning of dampening solution. The dampening solution on a printing plate creates an arbitrarily reimageable surface layer that when exposed to electromagnetic radiation and heat forms an image.

As used herein relational terms such as “first,” “second,” and the like may be used solely to distinguish one entity or action from another entity or action without necessarily requiring or implying any actual such relationship or order between such entities or actions. Also, relational terms, such as “offset”, “upstream”, “downstream”, “top,” “bottom,” “front,” “back,” “horizontal,” “vertical,” and the like may be used solely to distinguish a spatial orientation of elements relative to each other and without necessarily implying a spatial orientation relative to any other physical coordinate system. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

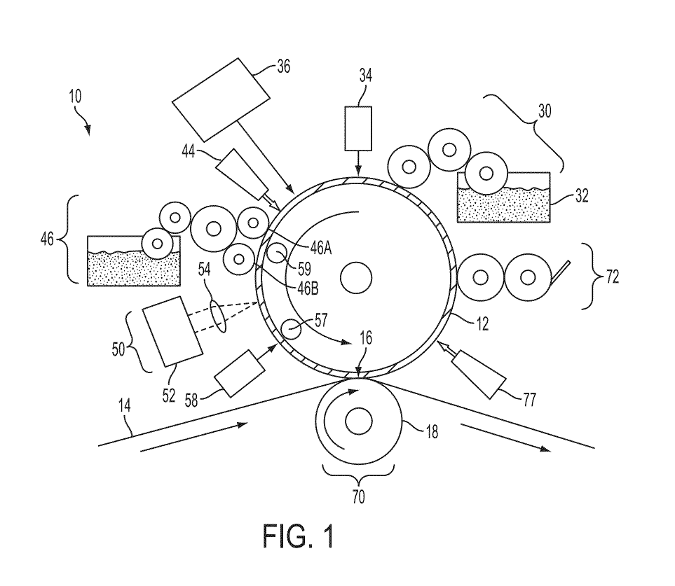

FIG. 1 illustrates therein a system 10 for variable lithography according to one embodiment of the present disclosure. System 10 comprises an imaging member 12, in this embodiment a printing plate, but may equivalently be a drum, belt, and the like, surrounded by a number of subsystems described in detail below. Imaging member 12 defines a surface that is made up of an elastomer and incorporates engineered nanomaterial filler which can have very high optical absorption properties. Incorporating such fillers increases the optical efficiency of the plate while maintaining plate properties necessary for a digital offset printing system. At transfer subsystem 70 the imaging member 12 applies an ink image to substrate 14 at nip 16 where substrate 14 is pinched between imaging member 12 and an impression roller 18. A wide variety of types of substrates, such as paper, plastic or composite sheet film, ceramic, glass, and the like may be employed. The inked image from imaging member 12 may be applied to a wide variety of substrate formats, from small to large, without departing from the present disclosure. A cleaning subsystem 72 is provided to remove remaining ink after transfer of the image to the substrate.

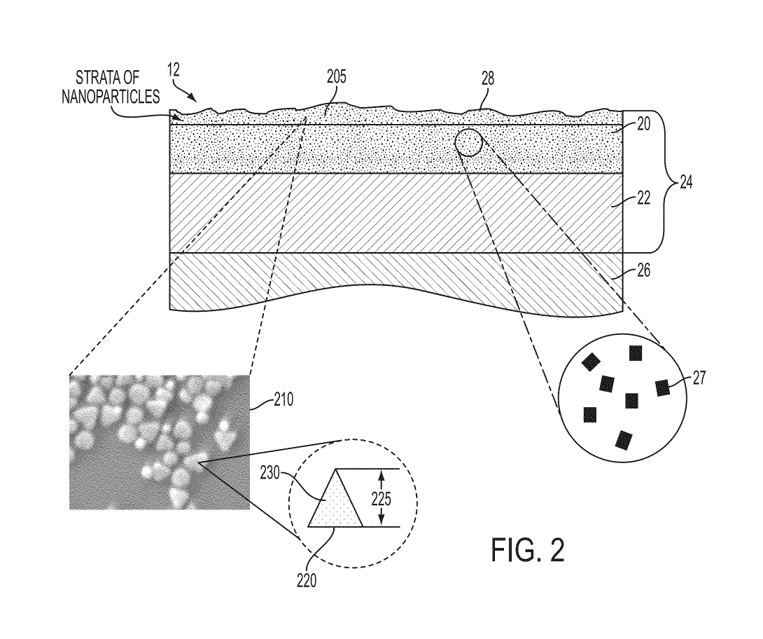

As shown in FIG. 1 at a first location around imaging member 12 is a dampening solution subsystem 30. Dampening solution subsystem 30 generally comprises a series of rollers (referred to as a dampening unit) for uniformly wetting the surface of imaging member 12 to form a reimageable surface layer. The thickness of the dampening solution is measured using a sensor 34 and can be used to automate the controls of dampening solution subsystem 30. It is well known that many different types and configurations of dampening units exist. The purpose of the dampening unit is to deliver a layer of dampening solution 32 having a uniform and controllable thickness. As shown in FIGS. 2-4 the imaging member primarily comprises a thin layer of fountain solution deposited on reimageable surface layer 20 (generally referred to as the plate layer and generally it is a layer formulated to exhibit the correct surface chemistry as well as optical absorption properties to create and retain a pattern in the fountain solution) which is supported by a structural mounting layer 22.

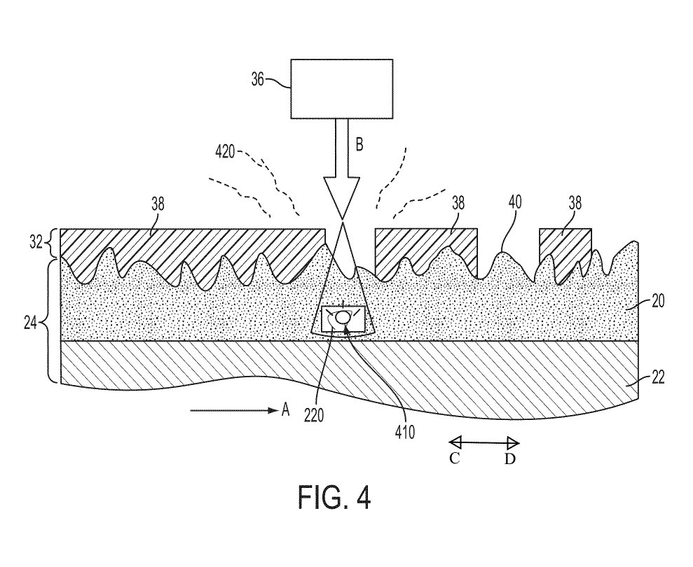

After applying a precise and uniform amount of dampening solution, in one embodiment an optical patterning subsystem 36, see FIG. 4, is used to selectively form a latent image in the dampening solution by image-wise evaporating the dampening solution layer using electromagnetic radiation, for example laser energy. In addition, an air knife 44 may be optionally directed towards reimageable surface layer 20 to control airflow over the surface layer before the inking subsystem 46 for the purpose of maintaining clean dry air supply, to controlled air temperature and to reduce dust contamination, while air knife 77 and cleaning subsystem 72 are used to remove any remaining dampening solution and ink.

After patterning of the applied layer of dampening solution 32 liked shown in FIG. 4 by optical patterning subsystem 36, an inker subsystem 46 is used to apply a uniform layer of ink over the applied layer of dampening solution 32 and reimageable surface layer 20. Inker subsystem 46 may consist of a “keyless” system using an anilox roller to meter an offset ink onto one or more forming rollers 46a, 46b. Alternatively, inker subsystem 46 may consist of more traditional elements with a series of metering rollers that use electromechanical keys to determine the precise feed rate of the ink. The general aspects of inker subsystem 46 will depend on the application of the present disclosure, and will be well understood by one skilled in the art.

In order for ink from inker subsystem 46 to initially wet over the reimageable surface layer 20, the ink must have low enough cohesive energy to split onto the exposed portions of the reimageable surface layer 20 (ink receiving dampening solution voids 40 like shown in FIG. 4) and also be hydrophobic enough to be rejected at regions 38 when formed with fountain solution. The ink employed should have a relatively low viscosity in order to promote better filling of voids 40 and better adhesion to reimageable surface layer 20. For example, if an otherwise known UV ink is employed, and the reimageable surface layer 20 is comprised of silicone or similar material, the viscosity and viscoelasticity of the ink will likely need to be modified slightly to lower its cohesion and thereby be able to wet the silicone. Adding a small percentage of low molecular weight monomer or using a lower viscosity oligomer in the ink formulation can accomplish this rheology modification. In addition, wetting and leveling agents may be added to the ink in order to further lower its surface tension in order to better wet the silicone surface. Additionally following application of the ink over reimageable surface layer 20, cohesiveness and viscosity can be enhanced by a rheology control subsystem 50 to partially cure or tack the ink image. This curing source may be, for example, an ultraviolet light emitting diode (UV-LED) 52, which can be focused as desired using optics 54.

In addition to this rheological consideration, it is also important that the ink composition maintain a hydrophobic character so that it is rejected by dampening solution such as regions 38 comprising fountain solution shown in FIG. 4 after the image has been patterned on imaging member 12. During the printing process, it is necessary to continuously treat the plate with a fountain solution (dampening solution) in order to maintain the hydrophilic character on the non-image areas. There are two competing results desired at this point. First, the ink must flow easily into voids 40 so as to be placed properly for subsequent image formation and the second is that the ink should flow easily over and off of dampening solution regions. However, it is desirable that the ink stick together in the process of separating from regions 38 that comprise the fountain solution, and ultimately it is also desirable that the ink adhere to the substrate and to itself as it is transferred out of voids 40 (FIG. 4) onto the substrate both to fully transfer the ink (fully empting voids 40) and to limit bleeding of ink at the substrate. The ink is next transferred to substrate 14 at transfer subsystem 70. In the embodiment illustrated in FIG. 1, this is accomplished by passing substrate 14 through nip 16 between imaging member 12 and impression roller 18. Adequate pressure is applied between imaging member 12 and impression roller 18 such that the ink within voids 40 (FIG. 4) is brought into physical contact with substrate 14. Adhesion of the ink to substrate 14 and strong internal cohesion cause the ink to separate from reimageable surface layer 20 and adhere to substrate 14. Impression roller or other elements of nip 16 may be cooled to further enhance the transfer of the inked latent image to substrate 14. Indeed, substrate 14 itself may be maintained at a relatively colder temperature than the ink on imaging member 12, or locally cooled, to assist in the ink transfer process. Cooling agents can be introduced at ducts 57 and 59 or by blowing cool air over the reimageable surface from jet 58 after the ink has been applied but before the ink is transferred to the final substrate.

FIG. 2 is a cut-away side view of a printing plate of an imaging member 12 and structural mounting layer with nano-heaters in the form of plasmonic nanoparticles embedded at or below the surface of the layer in accordance to an embodiment. In one embodiment, imaging member 12 comprises a thin reimageable surface layer 20 formed over (mounted to a structural backing or be the top layer on a printing blanket stack) a structural mounting layer 22 (for example metal, ceramic, plastic, and the like), which together forms a printing plate 24 that forms a rewriteable printing blanket or simply the reimaging portion. Printing plate 24 may consist only of reimageable surface layer 20 if a structural mounting layer is manufactured on surface layer 20 or combined with structural mounting layer 26.

Reimageable surface layer 20 consists of a polymer such as polydimethylsiloxane (PDMS, or more commonly called silicone) for example with a wear resistant filler material such as silica to help strengthen the silicone and optimize its durometer, and may contain catalyst particles that help to cure and cross link the silicone material. Alternatively, silicone moisture cure (aka tin cure) silicone as opposed to catalyst cure (aka platinum cure) silicone may be used. Reimageable surface layer 20 may optionally contain a small percentage of radiation sensitive particulate material 27 dispersed therein that can absorb laser energy highly efficiently. In one embodiment, radiation sensitivity may be obtained by mixing a small percentage of carbon black, for example in the form of microscopic (e.g., of average particle size less than 10 μm or nanoscopic particles (e.g., of average particle size less than 1000 nm) or nanotubes, into the polymer matrix. Other radiation sensitive materials that can be disposed in the silicone include graphene, iron oxide nanoparticles, nickel plated nanoparticles, and the like.

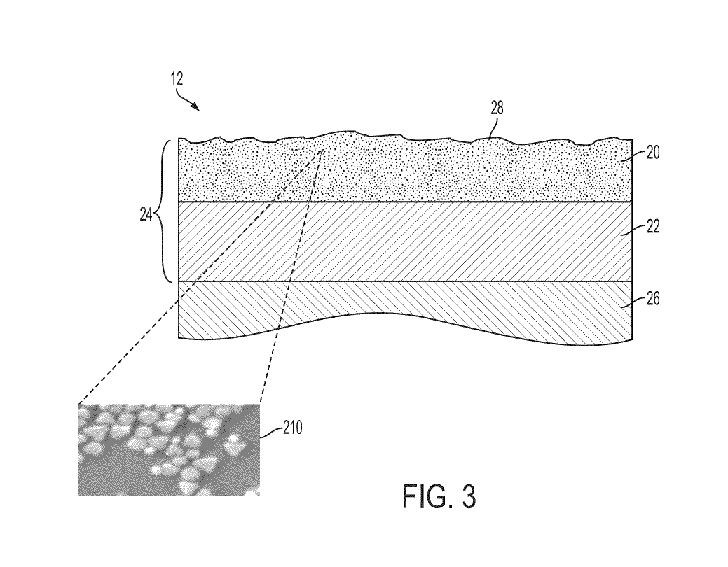

Alternatively, reimageable surface layer 20 may be tinted or otherwise treated to be uniformly radiation sensitive, as shown in FIG. 3. Still further, reimageable surface layer 20 may be essentially transparent to optical energy from a source, described further below, and the structural mounting layer or layer 22 may be absorptive of that optical energy (e.g., layer 22 comprises a component that is at least partially absorptive). It should be noted here that the reimageable surface layer 20 should ideally absorb most of the energy as close to an upper surface 28 as possible, to minimize any energy wasted in heating the dampening solution and to minimize lateral spreading of the heat so as to maintain high spatial resolution capability. Alternatively, it may also be preferable to absorb most of the incident radiant (e.g., laser) energy within the dampening solution layer itself, for example, by including an appropriate radiation sensitive component like particle 27 within the dampening solution that is at least partially absorptive in the wavelengths of incident radiation, or alternatively by choosing a radiation source of the appropriate wavelength that is readily absorbed by the dampening solution (e.g., water has a peak absorption band near 2.94 micrometer wavelength).

Structural mounting layer 22 is made up of a polymeric material (such as silicone or fluorosilicone). The structural mounting layer 22 can be anywhere from 50 micrometer (μm) to 1 millimeter (mm) thick and may be mounted to a metal backing 26.

Reimageable surface layer 20 can incorporate engineered nanomaterial filler (strata of nanoparticles 205), as well as other filler materials, in place of, or in addition to radiation sensitive particulate material 27, in the polymer matrix adjacent to the fountain solution interface. The nanomaterial filler is selected to efficiently absorb light at the same frequency as the electromagnetic radiation from optical patterning subsystem 36, such as a laser, being used in the printing system. The goal of adding nanomaterial filler of a particular composition, shape, and size is to use any electromagnetic radiation, i.e., laser light of a certain wavelength, which is not absorbed by the fountain solution to be absorbed by the reimageable surface layer 20 to generate heat. The intensity (I) of the electromagnetic radiation is selected to a level that is enough to heat the surface reimageable surface layer 20 and evaporate the fountain solution. No physical change to the nanomaterial filler is expected or desired since the process needs to be repeated. This is an important aspect because the reimageable surface layer 20 must be robust and exposed to electromagnetic radiation more than once. It is important that the nanomaterial filler do not undergo a physical or chemical change beyond heating up.

The thermal energy in the reimageable surface layer 20 is then transferred to the fountain solution causing it to evaporate. Because the elements that form the strata of nanoparticles 205 is a function of the composition, shape, and size of the nanomaterial for generating heat at a particular wavelength of radiation, the filler is called a plasmonic filler or plasmonic nanoparticles when referring to the whole strata. Each plasmonic nanoparticle can act as an antenna that can convert or transform a received energy like light and then re-emit a different energy like heat energy. The absorbed energy will cause the nanoparticle to resonate and to generate heat at that part of the reimageable surface layer 20 like at upper surface 28. The advantage of using a plasmonic material is that it can be tuned to have a strong response at a desired wavelength thus increasing the efficiency of the system. As can be seen, the plasmonic nanoparticles 210 comprise nanoparticles of different shapes and sizes. For example, Nanoparticle 220 is shown as a nanotriangle of a certain composition 230 and of a particular size 225. The size, of course, is typically much smaller than the wavelength of transmitted or reflected electromagnetic radiation as selected for the purpose of generating heat at a particular wavelength of radiation.

In the design of the reimageable surface layer 20 and selection of filler material, it is important to consider a number of design parameters such as chemical interaction with ink and dampening solution, optical absorption of each particle in the strata of plasmonic nanoparticles, maintaining particle shape consistency, and maintaining heat flow in the direction of the dampening solution which is in the direction of upper surface 28.

For maximum effect the plasmonic nanoparticles must be incorporated into the polymer matrix of the reimageable surface layer 20 at the face or interface between the surfaces, i.e., at the point or below where the reimageable surface layer 20 and fountain solution interact. Any chemical interactions with the polymer chemistry could make the reimageable surface layer 20 difficult (or impossible) to fabricate, and could also alter rewriteable printing blanket properties (such as hardness) which could impact the printing performance. Furthermore the reimageable surface layer 20 must be able to interact with the dampening solution, ink and paper. Therefore the plasmonic nanoparticles material must be sufficiently inert that it does not change the property of the imaging member 12 with regard to these elements of the printing system. Some examples of potential problems could include: the plasmonic nanoparticles physically binds to or absorbs the ink, the plasmonic nanoparticles promote poor adhesion between the reimageable surface layer 20 and dampening solution, the nanoparticles absorbs the dampening solution, the nanoparticles increases the tackiness of the imaging member 12 resulting in excessive adhesion between the reimageable surface layer 20 and paper, to name a few.

The selected plasmonic nanoparticles must have high absorption in the spectral range of the electromagnetic radiation in order to efficiently convert the electromagnetic radiation power into heat. To optimize this process it is necessary to design a reimageable surface layer 20 such that it not only absorbs efficiently in order to capture as much of the electromagnetic radiations energy as possible, but also such that it absorbs the energy close to the interface, i.e., the face of the matrix layer at rewriteable printing blanket, between the reimageable surface layer 20 and dampening solution to ensure that the electromagnetic radiation energy is used to pattern the dampening solution, and not just dissipated within the matrix. Ideally, most of the electromagnetic radiation energy will be converted to heat close to the surface at reimageable surface layer 20 which is generally shown as upper surface 28, so that the thermal energy can be efficiently transferred to the dampening solution causing it to heat up and evaporate. Also, it is important to note that the polymer matrix is an integral part of the patterned functional system and should not be separated from the functional microstructure so the plasmonic fillers are to absorb light energy and convert it to heat and should not be consumed or destroyed when patterning the fountain solution. The plasmonic nanoparticles can be embedded to within two (2) microns (μm) in the matrix layer as measured from the one face of reimageable surface layer 20 like upper surface 28. Suitable composition for the plasmonic nanoparticles can be as a metal (e.g., gold, silver), as a metallic composite (e.g., silver and silica, gold and silica), as a metal oxide (e.g. iron oxide, titanium oxide), as a metallic salt (e.g., potassium oxalate, strontium chloride), as an intermetallic (e.g., titanium aluminide, alnico), as an electric conductor (e.g., copper, aluminum), or other elements and combinations provided that the effect on the ink and structure is minimal. In non-limiting examples, the materials are gold, silver, nickel, platinum, titanium, silicon, palladium, aluminum, or a combination thereof provided that the effect on the ink and structure is minimal.

In addition to the material of the nanoparticles, the plasmonic effect is depended on the shape and size of the particles. In order to ensure that the plasmonic effect is not altered or derailed it is necessary to maintain consistent shape and size of the particles. Once embedded in the matrix of the reimageable surface layer 20 or printing plate 24 the shape and size can only be altered if the particles become attached or physically coupled causing the shape and size to change. A coating of the particles would prevent the coupling from occurring and, thus maintain, shape and size integrity.

An ideal filler or strata of nanoparticles will not be very thermally conductive in the lateral direction, i.e. along the surface of the plate, in order to preserve the resolution of the pattern as defined by the electromagnetic radiation. When the radiation hits the printing plate 24 or reimageable surface layer 20 at a specified location it is necessary and desirable to evaporate the damping solution at that location only. If the heat that is generated in the reimageable surface layer 20 can dissipate along the surface, rather than just into the dampening solution at that location, it is possible that the surrounding dampening solution will be heated and evaporate as well, resulting in a loss of pattern detail in the image at the dampening solution on imaging member 12.

A suitable coating for the nanoparticles is silica because of the number of advantages and availability. As discussed earlier the shape and size of the silver nanoparticles are important to defining their plasmonic resonance frequency. If two metal particles are to come into direct contact, from an electrical standpoint they become one particle, thus modifying the resonance frequency primarily because of the change in shape and size. The silica layer around the metal nanoparticle provides an insulating barrier and ensures that the metal nanoparticles will not come in direct contact, thus maintaining the size integrity with intended resonances peak of the particle ensemble. The silica coating encapsulates the metal nanoparticle in a material that can easily be incorporated into the reimageable surface layer 20 and will not significantly impact other variables in the print process. Silica is a common filler material in silicone and fluorosilicone materials, and thus silica coated particles can be incorporated into silicone and fluorosilicone materials without significantly impacting the cure chemistry. Silica is known to add strength to silicones and fluorosilicones. Thus silica coated particles could provide the added benefit of increasing wear resistance of the reimageable surface. In addition, silica is not known to interact with the ink or fountain solution. Thus silica coated, metal nanoparticles are an inert filler material that will result in the efficient patterning and evaporation of fountain solution at regions 38 (FIG. 4) without impacting the chemistry of the reimageable surface layer 20, ink or fountain solution, and minimizing accumulative effect such as heat fluxes and Coulomb interaction due to superposition of scattering electric fields with the resonant frequency of a nanoparticle.

The plasmonic nanoparticles are expected to be metal coated in silica whose material (composition), shape and size are optimized to efficiently absorb the laser energy of interest. For example, while not limited thereto, silver triangular nanoparticles with side dimension of about 120 nanometer (nm), and coated in silica, would be a good choice of filler material for use with a near infrared (IR) laser operating at a wavelength of 1080 nm. The exact material, composition and geometry of the filler will need to be optimized for the specified electromagnetic source or optical system. The flow of thermal energy in the reimageable surface layer 20 also needs to be considered. The nanomaterial filler or nanoparticles must be embedded at or below the first few microns of reimageable surface layer 20, but may also be distributed various depths throughout the reimageable surface layer 20 depending on cost and manufacturing approach.

FIG. 3 is a cut-away side view of a printing plate and plasmonic nanoparticles 210 in accordance to an embodiment. The reimageable surface layer 20 of imaging member 12 comprises an elastomer (silicone or fluorinated silicone) along with plasmonic nanoparticles 210. The reimageable surface can be manufactured through solution processing. The elastomer material and appropriate plasmonic nanoparticles 210 can all be mixed together into a liquid base material which can then be manipulated into the appropriate geometry and cured to form part of the reimageable surface layer 20 on a structural mounting layer 22 and backing material 26. If the plasmonic nanoparticles 210 are to be dispersed through the entire reimageable surface layer 20, then they can be mixed into the base material which can then be processed into the final printing plate 24 by either casting, flow-coating, using a bird-bar, or any other method of creating a sufficiently thin and uniform liquid film.

If the plasmonic nanoparticles are only to be dispersed in the top micron (0-1 microns) layer or embedded (0-2 microns) in the reimageable surface 20 of printing plate 24 (imaging member 12), then a more complex manufacturing approaches must be used. One approach would be to spread the plasmonic nanoparticles on the surface like at reimageable surface layer 20 on which the plate will be prepared by first drop-casting or spray coating the nanoparticle solution and allowing it to dry. Then the base material is added to that surface by casting, flow-coating or using a bird-bar. The plasmonic nanoparticles should adhere to the surface of the base material as the plate cures. When the plate is removed from the casting surface the nanoparticles will be retained in the surface of the reimageable surface layer 20. This approach has the limitation that the nanoparticles will only appear on the surface of the printing plate 24 on top of reimageable surface layer 20, and may not be fully, or robustly, incorporated (embedded) into the printing plate 24 like the strata of nanoparticles shown in FIG. 2 which in the upper portion of reimageable surface layer 20.

Another approach would be to form two base solutions, one that includes the plasmonic nanoparticles, and one that does not and then these solutions can be combined into reimageable surface layer 20. A very thin layer of the plasmonic base layer can first be placed on the surface where the reimageable surface layer 20 will be prepared. This can be done by using a bird-bar, flow-coating, or by diluting the base material with a compatible solvent and then spray coating the reimageable surface layer 20 preparation surface. Once this thin layer has partially (or fully) cured the second base material can be applied (by casting, flow-coating or the use of a bird-bar) to form the remainder of the reimageable surface layer 20. This approach has the advantage of creating a layer of material which robustly incorporates the plasmonic nanoparticles at the printing surface. This approach also creates the additional challenge of designing a process where the different layers of the reimageable surface layer 20 are well adhered to one and other.

A variation of this approach would be to first prepare the bulk reimageable surface layer 20 or printing plate without plasmonic particles (using approaches such as casting, flow-coating or using a bird-bar) and then using a bird-bar or spray coating to deposit a very thin layer of base material, with plasmonic filler incorporated in it, onto the surface of the reimageable surface to have a completed printing plate 24. These are just some approaches to manufacturing reimageable surface layer 20 described above. Other variations are possible without departing from the scope of the present subject matter.

FIG. 4 is a magnified cut-away side view of the printing plate shown in FIG. 2, having a dampening solution applied thereover and patterned by a beam B in accordance to an embodiment. With reference to FIG. 4, which is a magnified view of a region of reimageable portion 24 having a layer of dampening solution 32 applied over reimageable surface layer 20, the application of optical patterning energy (e.g., beam B) from optical patterning subsystem 36 results in selective evaporation of portions the layer of dampening solution 32. Evaporation is augmented by the heat 410 generate by plasmonic nanoparticle 220 which is in the line of sight of beam B or any other incident wavelength of electromagnetic radiation. Furthermore, in the embodiment the fountain solution evaporates as a function of electromagnetic (EM) energy such as laser causing a physical change and not a chemical change. The electromagnetic radiation (e.g., laser light) that hits reimageable surface layer 20 is defining a desired pattern. If reimageable surface layer 20 is thermally conductive than heat can travel laterally (to the left and right of the illustration following arrows C & D) which will reduce the definition of the desired feature of an image. Using particle absorbers is advantageous here because the particle will absorb the energy and convert it to heat, but won't be able to easily transfer it away laterally unless it is near another particle. When using less efficient absorber a high density of particles is needed to trap enough light, but also results in a lateral conduction path. With plasmonic particles—each having an optimized composition, shape, and size—a lower density of particles are possible reducing the likelihood that heat can travel laterally.

Evaporated dampening solution becomes part of the ambient atmosphere surrounding system 10. This produces a pattern of dampening solution regions 38 and ink receiving voids 40 over reimageable surface layer 20 at a lower energy footprint since evaporation is achieved by direct EM contact and heat generated from the plasmonic portion of the plate. Relative motion between imaging member 12 or moving surface and optical patterning subsystem 36, for example in either direction of arrow A, permits a process-direction patterning of the layer of dampening solution 32.

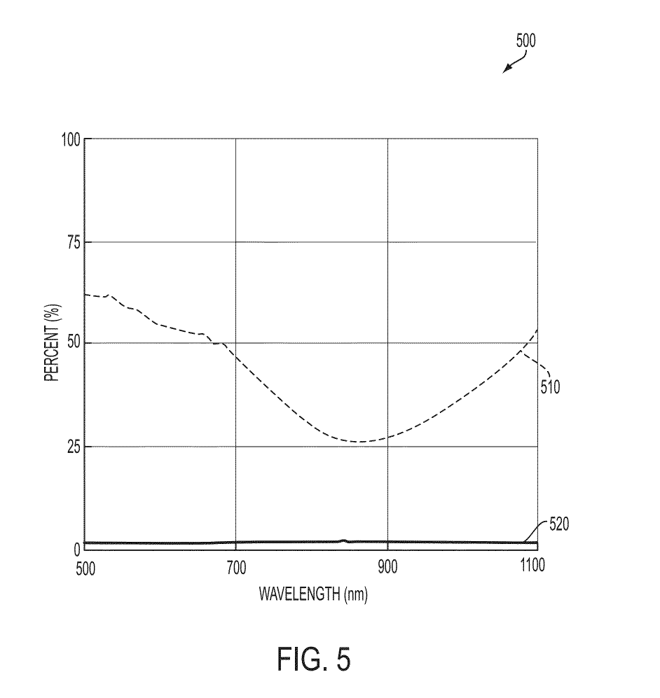

FIG. 5 is an illustration of measured optical transmission and diffuse reflectivity 500 of plasmonic nanoparticles in accordance to an embodiment. In particular, FIG. 5 shows the measured optical transmission 510 and diffuse reflectivity 520 of commercially available silica coated silver nanoparticles. The spectrum was measured by taking a drop of a commercially available nanoparticle suspension and placing it on a glass slide and allowing it to dry. The dried drop covered a surface of about 0.5 cm² in area. The data shows that at a wavelength of 900 nm approximately twenty five percent (25%) of the light is passed through the particles 510 and three percent (3%) of the light is reflected back 520. From the data it can be concluded that about seventy two percent (72%) of the light (at 900 nm) is absorbed by the nanoparticles on the glass slide. The absorption of incident light by the silica coated silver nanoparticle with the subsequent energy transfer to the medium surrounding the metal nanoparticle would cause localized heating of the object. Commercially available nanoparticle can be acquired from a wide selection of commercial sources such as nanoComposix Inc. (San Diego, Calif.), Labs LLC (Fayetteville, Ark.), Nanoshel LLC (Wilmington, Del.), and the Nanomaterial Store (Fremont, Calif.).

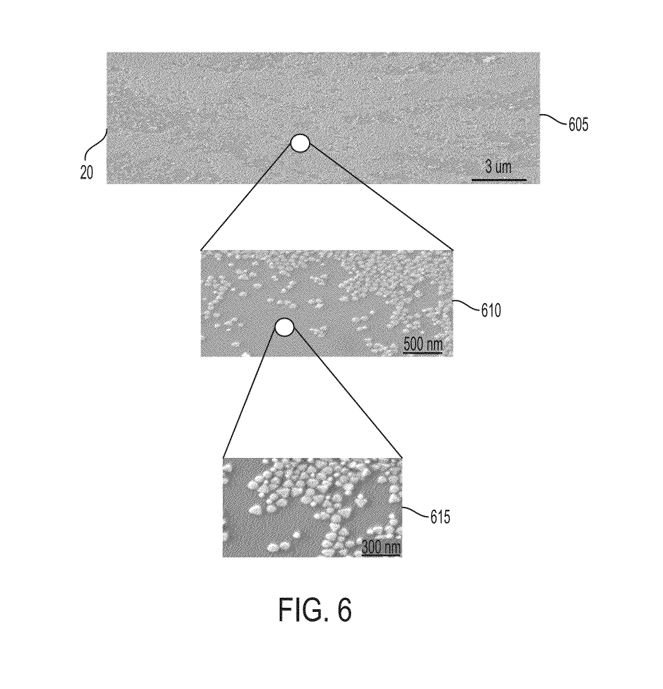

FIG. 6 are scanning electron micrographs (SEM) of silver nanoparticles, after being deposited on a glass slide that were used to create the transmission and reflectivity measurement shown in FIG. 5 in accordance to an embodiment. The three views (images) shown are scanning electron micrographs (SEM) of the silver nanoparticles, after being deposited on a glass slide, that were used to create the transmission and reflectivity measurement shown in FIG. 5. The various views 605, 610, 615 illustrate the appearance of the filler as if they had been applied or embedded into plate 20. View 605 shows the nanoparticles at 3 μm; view 610 shows the nanoparticles at 500 nm; and view 615 shows the nanoparticles at 300 nm. The images show that the nanoparticles are arranged as a single layer of moderate density in the regions that were surveyed by SEM. Visually the areas that were surveyed by SEM are similar to approximately seventy percent (70%) of the dried drop area, whereas the remaining thirty percent (30%) likely had more than one layer of particles. In forming a strata like 205 shown in FIG. 2, the total layer thickness and the thickest regions is no more than a few monolayers. From the above data, illustrated in FIG. 5, we can conclude that only a few layers of nanoparticles will be needed to achieve a very high level of absorption at the resonant frequency (illustrated for a wavelength of 900 nm) of a wave source such as optical subsystem 36.

By adjusting the geometry (shape and dimensions) and composition of the particles (silver, gold, and the like) it should be possible to tune these nanoparticles to have a resonance frequency close to 1080 nm which will match the spectral range of a laser commonly used in printing systems. However, should another laser be selected it should be possible to design a nanoparticle filler with a different dimension, shape and/or material to obtain a resonance frequency that is matched to the laser. It is possible to design a reimageable surface layer 20 that has these particles dispersed in the matrix within 1 μm of the plate surface or deeper at the 2 μm. Because most of the laser energy is expected to be absorbed within the first few monolayers of plasmonic particles it is expected, assuming sufficient particle density, that most of the laser energy will be absorbed in the top 500 nm (0.5 μm) or less of the plate if embedded/deposited within the initial 1 μm of the plate. The spectrally matched nanoparticles will therefore provide a filler material that will efficiently convert electromagnetic energy such as laser to heat, and do so close to the surface of the plate, allowing for an efficient transfer of thermal energy from the plate to the fountain solution. Both of these elements should increase the efficiency of the system by allowing for a reduction in laser power, an increase in process speed, or both.

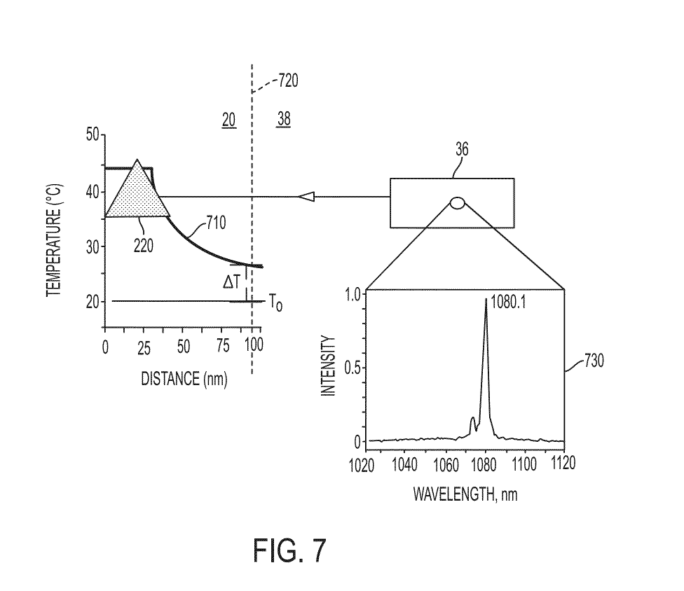

FIG. 7 is an illustration of heat flow for a plasmonic nanoparticle as a function of distance for a giving wavelength of electromagnetic radiation in accordance to an embodiment. As shown, the nanoparticle 220 used in this illustration is taken to be at least one triangular nanoparticle that could be any or a combination of various materials (such as silver (Au) or gold (Ag)). Each side of the triangular plate is 100 nm in length and the thickness of the plate is around 20 nm. The nanoparticle is located in the first 1 μm of the printing surface (reimageable surface 20) and the particles form a three dimensional lattice where the particle spacing is 200 nm in all three dimensions. As shown a particle like nanoparticle 220 is a silver plates that efficiently releases heat under optical excitation. The mechanism of heat release as explained earlier is simple, the laser electric field 730, from optical patterning subsystem 36, strongly drives mobile carriers inside the nanoparticle, and the energy gained by carriers turns into heat. Then the heat diffuses 710 away from the nanoparticle towards surface 28 like shown in FIG. 2 and leads to an elevated temperature (ΔT) of the surrounding medium such as reimageable surface layer 20 and fountain solution (regions 38 at FIG. 4) which is in intimate contact with reimageable surface layer 20. This causes the solution on the imaging member 12 to experience energy from two ends, at the top from the radiating source (36) and at the bottom from local heating or plasmonic heating (220 and collectively 210). Evaporation is enhanced from the elevated temperature. Heat generation becomes especially strong in the case of metal nanoparticles in the regime of plasmon resonance. Plasmon resonance is a collective motion of a large number of electrons. The temperature distribution around optically stimulated nanoparticle is described by the usual heat transfer equation which is known to those in the art. The heat generation rate and temperature increase depend on the physical properties of a material which for a reimageable surface comprises a polymeric material such as silicone, fluorosilicone, or elastomer. The elevated temperature (ΔT) will cause the reimageable surface layer to heat up at the interface 720 (upper surface 28 at FIG. 3) between the mediums and eventually will cause the fountain solution (liquid solution or dampening solution layer) to evaporate forming the void 40 shown in FIG. 4.

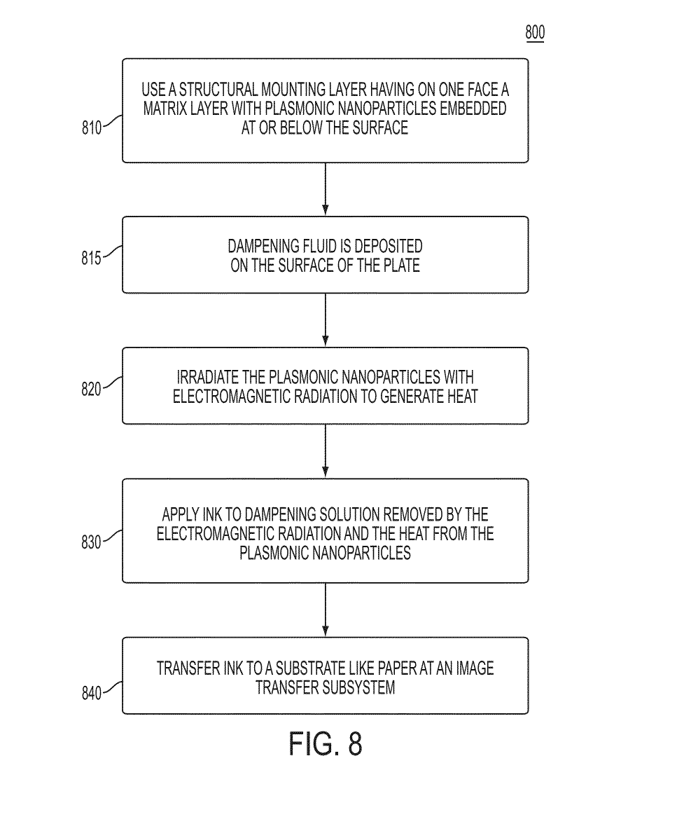

FIG. 8 is a flowchart of a method 800 to produce a latent image on an arbitrarily reimageable surface layer 20 (printing plate 24) by selectively removing portions of a dampening solution on the surface using electromagnetic radiation and heat from plasmonic nanoparticles in accordance to an embodiment. The evaporation image producing process (method 800) in a variable data lithography system, illustrated in FIG. 1, comprises action 810 begins by using a printing plate 24 or reimageable surface layer 20 having on one face a matrix layer with plasmonic nanoparticles embedded at or below the surface; the process continues with action 815 where dampening fluid (DF) is deposited on the surface of the plate that is selectively evaporated to form a latent image thereon when exposed to electromagnetic radiation such as a laser light; the process continues with action 820 by irradiating the DF and the plasmonic nanoparticles with electromagnetic radiation to generate heat at the particles and evaporation at the DF; after forming an image the process continues with action 830 which applies ink to reimageable surface layer 20 that includes DF and/or dampening solution voids 40 removed by the electromagnetic radiation and the heat from the plasmonic nanoparticles; and the process at action 840 transfers the applied ink to a substrate like paper at an image transfer subsystem such as 70 shown in FIG. 1. Method 800 can be repeated in part or in whole to print on a substrate using plates with plasmonic nanoparticles.

In the preceding paragraphs, example embodiments of the invention were described. Embodiments have been described where a printing plate surface that is made up of an elastomer and incorporates engineered nanomaterial filler which can have very high optical absorption properties (plasmonic effect). Incorporating such a filler would greatly increase the optical efficiency of the printing plate while maintaining plate properties necessary for a digital offset printing system like shown in FIG. 1. These embodiments are presented for purposes of illustration rather than of limitation, and minor changes may be made to the example embodiments without departing from the inventive principle or principles found therein. It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the followings claims.

1. An imaging member for disposition within a variable data lithography system, comprising:
a plate layer having on one face thereof a matrix layer with plasmonic nanoparticles embedded at or below the surface of the matrix layer,
wherein said plasmonic nanoparticles generate heat when exposed to an incident wavelength of electromagnetic radiation;
an arbitrarily reimageable surface layer formed by a dampening solution disposed over said plate layer;
wherein the plasmonic nanoparticles at said plate layer are in thermal contact with said arbitrarily reimageable surface layer;
wherein the electromagnetic radiation and the heat from the plasmonic nanoparticles selectively remove portions of the dampening solution so as to produce a latent image on the plate layer;
wherein the plasmonic nanoparticles have a controlled shape to efficiently absorb light at the same frequency as the electromagnetic radiation in the variable data lithography system;
wherein the controlled shape has a physical size that is smaller than the wavelength of the electromagnetic radiation;
wherein the plasmonic nanoparticles are encapsulated to provide an insulating barrier and to prevent direct contact between particles.

2. (canceled)

3. The imaging member of claim 1, wherein the controlled shape is at least one nanotriangle, nanotube, nanorectangle, or nanodisc.

4. (canceled)

5. (canceled)

6. The imaging member of claim 1, wherein a silica coating encapsulates the plasmonic nanoparticles.

7. The imaging member of claim 3, wherein the plasmonic nanoparticles are formed from silver, gold, silica, copper, aluminum, or any combination thereof.

8. The imaging member of claim 7, wherein the portions of the dampening solution is removed through evaporation.

9. The imaging member of claim 7, wherein the plasmonic nanoparticles are embedded to about two (2) microns in the matrix layer as measured from the surface.

10. The imaging member of claim 7, wherein the plasmonic nanoparticles are dispersed in the matrix layer at various depths ranging from zero (0) to two (2) microns as measured from the surface.

11. A variable data lithography system, comprising:
an imaging member comprising an arbitrarily reimageable surface having on one face thereof a matrix layer with plasmonic nanoparticles embedded at or below the surface of the matrix layer, wherein said plasmonic nanoparticles generate heat when exposed to an incident wavelength of electromagnetic radiation;
a dampening solution subsystem for applying a layer of dampening solution to an arbitrarily reimageable surface layer;
wherein the plasmonic nanoparticles at said imaging member are in thermal contact with said layer of dampening solution;
a patterning subsystem for selectively removing portions of the dampening solution layer, by electromagnetic radiation and the heat from the plasmonic nanoparticles, so as to produce a latent image in the dampening solution;
an inking subsystem for applying ink over the arbitrarily reimageable surface layer such that said ink selectively occupies regions of the reimageable surface layer where dampening solution was removed by the patterning subsystem to thereby produce an inked latent image;
wherein the plasmonic nanoparticles have a controlled shape to efficiently absorb light at the same frequency as the electromagnetic radiation;
wherein the controlled shape has a physical size that is smaller than the wavelength of the electromagnetic radiation;
wherein the plasmonic nanoparticles are encapsulated to provide an insulating barrier and to prevent direct contact between particles; and
an image transfer subsystem for transferring the inked latent image to a substrate.

12. (canceled)

13. The variable data lithography system of claim 11, wherein the controlled shape is at least one nanotriangle, nanotube, nanorectangle, or nanodisc.

14. (canceled)

15. (canceled)

16. The variable data lithography system of claim 13, wherein a silica coating encapsulates the plasmonic nanoparticles.

17. The variable data lithography system of claim 13, wherein the plasmonic nanoparticles are formed from silver, gold, silica, copper, aluminum, or any combination thereof.

18. The variable data lithography system of claim 17, wherein the portions of the dampening solution is removed through evaporation.

19. The variable data lithography system of claim 17, wherein the plasmonic nanoparticles are embedded to about two (2) microns in the matrix layer as measured from the surface.

20. The variable data lithography system of claim 17, wherein the plasmonic nanoparticles are dispersed in the matrix layer at various depths ranging from zero (0) to two (2) microns as measured from the surface.

21. A method comprising:
using a plate having on one face thereof a matrix layer with plasmonic nanoparticles embedded at or below the surface of the matrix layer;
irradiating said plasmonic nanoparticles with electromagnetic radiation to generate heat;
wherein the electromagnetic radiation and the heat from the plasmonic nanoparticles selectively remove portions of a dampening solution so as to produce a latent image on the arbitrarily reimageable surface layer;
wherein the plasmonic nanoparticles have a controlled shape to efficiently absorb light at the same frequency as the electromagnetic radiation;
wherein the controlled shape has a physical size that is smaller than the wavelength of the electromagnetic radiation;
wherein the plasmonic nanoparticles are encapsulated to provide an insulating barrier and to prevent direct contact between particles.

22. (canceled)

23. The method of claim 21, wherein the controlled shape is at least one nanotriangle, nanotube, nanorectangle, or nanodisc.

24. (canceled)

25. (canceled)

26. The method of claim 23, wherein a silica coating encapsulates the plasmonic nanoparticles.

27. The method of claim 26, wherein the plasmonic nanoparticles are formed from silver, gold, silica, copper, aluminum, or any combination thereof.

28. The method of claim 27, wherein the portions of the dampening solution is removed through evaporation.

29. The method of claim 27, wherein the plasmonic nanoparticles are embedded to about two (2) microns in the matrix layer as measured from the one face of the structural mounting layer.

30. The method of claim 27, wherein the plasmonic nanoparticles are dispersed in the matrix layer at various depths ranging from zero (0) to two (2) microns as measured from the one face of the structural mounting layer.

31. The method of claim 21, further comprising:
applying ink in a layer such that said ink layer readily separates in regions over imaging surface covered by dampening solution and into regions over said imaging surface at which dampening solution has been removed by the electromagnetic radiation and the heat from the plasmonic nanoparticles; and
transferring said ink to a substrate at an image transfer subsystem.
